(19) United States
(12) Patent Application Publication
(10) Pub. No.: US 2025/0011198 A1
(43) Pub. Date: Jan. 9, 2025

(54) IN-LINE ELECTROCHEMICAL REACTOR

(71) Applicant: TTD GLOBAL PTY LTD, South Australia (AU)

(72) Inventors: Daniel Vallelonga, South Australia (AU); Sergio Ferro, South Australia (AU)

(73) Assignee: TTD GLOBAL PTY LTD, South Australia (AU)

(21) Appl. No.: 18/571,024

(22) PCT Filed: May 10, 2022
(86) PCT No.: PCT/AU2022/050439

§ 371 Date: Dec. 15, 2023

(30) Foreign Application Priority Data
Jun. 15, 2021 (AU) 2021901789

(51) Int. Cl. C02F 1/461; C02F 1/467; C02F 103/02

(52) U.S. Cl. CPC C02F 1/46109; C02F 1/467; C02F 2001/46142; C02F 2001/46152; C02F 2103/02; C02F 2303/04

(57) ABSTRACT

Electrochemical reactor comprising an electrode assembly, the electrode assembly including a plurality of electrode plates, at least two circular spacers, each having a central opening having a plurality of apertures/slots for receiving and spacing apart the plurality of electrode plates, and at least two lateral spacers inserted into the central openings of the at least two circular spacers, each having slots to engage with the at least two circular spacers. The electrochemical reactor can be applied for the in-line electrolytic treatment of water/wastewater and, more particularly, for maintaining or improving the water quality of drinking water supplies, swimming pools, ponds, irrigation waters, aquatic mammal tanks, spas, fountains, cooling towers and the like, and for the destruction of targeted contaminants (which can also be of microbiological nature) in water/wastewater streams.

### TECHNICAL FIELD

The present invention concerns an electrochemical reactor for the in-line treatment of aqueous solutions containing halides and, in particular, for the electrolytic treatment of drinking water.

### BACKGROUND

Drinking water supplies are commonly disinfected with an oxidiser like chlorine or ozone. Drinking water and wastewater treatment plants may use on-site electrolytic generators to produce the oxidiser used for disinfection and/or as part of an advanced oxidation system for targeted organics destruction. Swimming pools, spas, water features such as ornamental fountains and the like are commonly sanitised using either electrolytic chlorination or ozonation.

Conventional apparatus used to sanitise water in pools and the like includes electrolytic chlorination systems, or “salt” chlorination systems. These systems utilise an electrolytic cell or “chlor-alkali” cell, typically comprising a submerged positively charged anode, a negatively charged cathode, and an electrical energy source for applying a current across the gap between the anode and cathode. The electrolytic cell is fed with a solution including a source of chlorides which, when oxidised, forms chlorine gas. Typically, the chloride source comprises an alkali metal chloride salt such as sodium chloride or potassium chloride, although other sources, such as hydrochloric acid and the like may also be used. When current is applied across the anode and cathode gap, the sodium and chloride ions disassociate with chloride ion concentrating in the solution nearby the anode and the sodium ion concentrating in the solution nearby the cathode. Chlorine and/or oxygen gas is generated on the anode surface and hydrogen gas is generated on the cathode surface, which is released back into the flowing water. The dissolved chlorine gas reacts with the water to create hydrochloric acid (HCl) and hypochlorous acid (HOCl). At concentrations greater than 1 ppm, hypochlorous acid minimises or prevents the growth of algae, bacteria, and other microorganisms. When a single-compartment electrolytic cell is used, the sodium hydroxide and hypochlorous acid recombine to form sodium hypochlorite (bleach), which is the active oxidiser transported back into the main body of water to prevent microorganism growth. Typical examples of salt chlorination systems are disclosed in Kosarek (U.S. Pat. No. 4,361,471), Wreath and Keller (U.S. Pat. No. 4,613,415), Lynn et al. (U.S. Pat. No. 5,362,368), Bess and Smith (WO 2007/022572 A1), and Poyet (AU 2017/225104 B2), the entire disclosures of which are incorporated herein by this reference.

Conventional apparatus for sanitising water using ozonation typically comprises a high efficiency ozone generator and a venturi mixer or inductor port that injects ozone gas into the water to oxidise contaminants in the water. Exemplary ozonation systems which have been found to be particularly effective in pools and spas are disclosed in Martin and Lavelle (U.S. Pat. Nos. 6,500,332, 6,129,850 and 6,372,148), and Martin (U.S. Pat. No. 6,331,279). Other ozonation systems are disclosed in Karlson (U.S. Pat. No. 5,855,856), Morehead (U.S. Pat. No. 5,451,318), Engelhard (U.S. Pat. No. 5,709,799), and Karlson and Chamblee (U.S. Pat. No. 5,518,698). The entire disclosure of each of these patents is incorporated herein by this reference.

Ozone has been recognised by the FDA to be more than 200 times stronger than chlorine in microbial kill and can react at higher oxidation levels than can be achieved safely with chlorine. However, dissolved ozone can exist in water for only a very short period before it reacts and is converted back into oxygen gas. Thus, dissolved ozone is not an effective residual sanitiser, in contrast to chlorine which has relatively steady and consistent residual sanitisation properties.

To overcome the short residence time of ozone and the high vapor pressure of chlorine in hot spa water, spa and pool owners may add sodium bromide salt to the water. Bromine has a very low vapor pressure compared to chlorine, thus it does not vaporise as readily in aerated hot spa water. Dissolved ozone or sodium hypochlorite will react with the bromide ion to create the hypobromite ion in the water. Hypobromous acid or sodium hypobromite salt will oxidise ammonia to nitrogen gas without creating an intermediate amine compound like the chlorine oxidiser.

Attempts to combine the favourable properties of chlorination and ozonation are described in Tamir (U.S. Pat. No. 4,804,478) and Gargas (U.S. Pat. Nos. 6,517,713, 6,551,518 and 6,814,877 B2). The entire disclosure of each of these patents are incorporated herein by this reference.

Advanced oxidation processes (AOPs) are defined as those processes that optimise the production of hydroxyl radicals (OH^{●}) and oxygen species without the addition of metal catalysts. In water treatment, AOPs refer specifically to processes where oxidation of organics by hydroxyl radicals (OH^{●}) occurs specifically through processes that involve ozone (O₃), hydrogen peroxide (H₂O₂) and/or ultraviolet light (UV with wavelengths<300 nm), Fenton oxidation, and sonolysis. All AOP systems generate hydroxyl radicals via a pressure (cavitation), chemical reaction, electric field, or photon-based process, or combinations thereof. The ability of an oxidant to initiate chemical reactions is measured in terms of its oxidation potential. The end-product of complete oxidation (mineralisation) of organic compounds is carbon dioxide (CO₂) and water (H₂O). The oxidation potential of hydroxyl radicals at 2.8V is high relative to ozone at 2.1V and chlorine at ˜1.4V.

Depending on the existing oxidants in the water and whether salts, anions, ozone and/or air are added to the water, a number of other oxidisers may be generated under AOP conditions including ozone, hydrogen peroxide, and several other peroxides (e.g., peroxomonosulphates, peroxo-disulphates, peroxycarbonates, peroxodiphosphates), which are all good disinfectants and oxidisers.

There still exists a need for an electrolytic water treatment system that can operate as a combined advanced oxidation process/residual oxidant generator for treatment of a wide range of water qualities and uses. Furthermore, there exists a need for such systems which can be manufactured simply and inexpensively, which can easily fit or be retrofitted into a conventional drinking water plant, industrial treatment plant, swimming pool, spa, cooling tower, irrigation channel, mining process, water feature or the like, and which requires relatively little maintenance.

### SUMMARY OF THE INVENTION

The present invention relates to water/wastewater treatment systems and, more particularly, to systems and methods for maintaining the water quality of drinking water supplies, swimming pools, ponds, irrigation waters, aquatic mammal tanks, spas, fountains, cooling towers and the like, and for the destruction of targeted contaminants (which can also be of microbiological nature) in water/wastewater streams such as from municipal water/wastewater treatment plants, ground water streams, industrial water/wastewaters and water from larger bodies such as streams and rivers, and for the preparation of lixiviant solutions suitable for solution mining applications.

The present invention comprises an apparatus for generating a mixed oxidant stream containing oxidants such as: ozone, hydrogen peroxide and other peroxide species, hydroxyl radicals, as well as chlorine-based oxidants, the quantities and concentrations of which are determined by the quantity and type of compounds precursors that are fed into the electrochemical reactor, the water flow rate, the intensity of the current fed to the electrochemical reactor, and the electrode material.

In the particular case of drinking water treatment, the apparatus must be fit for purpose and comply with relevant regulations. In Australia, the Australian Building Codes Board manages and administers the so-called WaterMark Certification Scheme (the Scheme), which is a mandatory certification scheme for plumbing and drainage products to ensure they are fit for purpose and appropriately authorised for use in plumbing and drainage installations. For materials and products to be certified and authorised for use through the Scheme, specific standard tests must be passed. Currently, testing of products for use in contact with drinking water is standardised by AS/NZS 4020, which specifies requirements for the suitability of products for use in contact with drinking water, with regard to their effect on the quality of water. These products include pipes, fittings, components, and materials used in coating, protection, lining, jointing, sealing and lubrication applications in the water supply and plumbing industry. AS/NZS 4020 requires that products intended for use in contact with drinking water are tested by exposure to test water. Where appropriate, a scaling factor is applied to such tests to compensate for differences between laboratory and field conditions. In addition, WMTS-103 WaterMark Technical Specification sets out the minimum requirements for water treatment system componentry, other than those specified in AS/NZS 3497, for use on domestic drinking water supply (private or public). It may be applied to systems used in commercial or industrial applications. Water treatment units and water sanitisers (including UV) are among the systems contemplated in WMTS-103, which prescribes the following requirements for the water system treatment:
Products in contact with drinking water shall comply with AS/NZS 4020;
When subjected to permanent hydrostatic pressure test of 2+0.1, −0 MPa (or 20 bars) at the manufacturer's stated maximum operating temperature of ‘x’+5, −0° C. for 60 min+10, −0 s, all components shall not leak (Hydrostatic Pressure test);
All components shall be subjected to cyclic testing of 100,000 pressure cycles at a minimum pressure cycle frequency of 30±2 cycles/min at a temperature of 23±2° C. and a minimum and maximum pressure range of 0 to 1,034 kPa, or 10.34 bars (Endurance test);
When tested at ambient temperature, components subjected to permanent hydrostatic pressure shall meet a minimum burst pressure of 3.5 MPa (or 35 bars) when tested at ambient temperature (Burst Pressure test).

According to the above requirements, the present invention concerns an electrochemical reactor able to pass the prescribed Hydrostatic Pressure test, Endurance test, and Burst Pressure test.

The present invention comprises an apparatus that can employ any number or combination of types of electrodes in an electrochemical cell(s) such as, but not limited to: dimensionally-stable electrodes, boron-doped diamond electrodes, ceramic titanium (Ebonex®) electrodes, glassy carbon or aerogel electrodes, lead-oxide electrodes, titanium, nickel, platinum, copper electrodes with specialty coatings, expendable electrodes such as iron or aluminium for electrocoagulation, or silica-based electrodes. The choice of electrode to be used in the present invention depends upon a large number of variables such as, but not limited to, the water treatment process(es) selected, the contaminants of interest, the influent water quality, the desired water quality, the efficiencies of the treatment processes, and costs associated with the treatment process.

In certain embodiments, the present invention includes an electrochemical reactor comprising an electrode assembly, the electrode assembly including a plurality of electrode plates; at least two circular spacers, each having a central opening having a plurality of apertures/slots for receiving and spacing apart the plurality of electrode plates; at least two lateral spacers inserted into the central openings of the at least two circular spacers, each having slots to engage with the at least two circular spacers.

### DESCRIPTION OF THE FIGURES

FIG. 1 shows a perspective elevation (isometric view) of an embodiment of the electrochemical reactor of the present invention;

FIG. 2 shows a side view of the embodiment of the electrochemical reactor as shown in FIG. 1;

FIG. 3 shows an end view of the embodiment of the electrochemical reactor as shown in FIG. 1

FIG. 4 shows a section view of the electrochemical reactor of the present invention according to plan trace A-A in the terminal end view of FIG. 3;

FIG. 5 shows a perspective elevation (isometric view) of the electrode assembly illustrating the spatial placement of the electrode stacks in accordance with the electrochemical reactor of FIG. 1;

FIG. 6 is a first end view of the electrode assembly as shown in FIG. 5;

FIG. 7 is a side view of the electrode assembly as shown in FIG. 5;

FIG. 8 is an underside view of the electrode assembly as shown in FIG. 5;

FIG. 9 is a perspective, exploded view of both the anode and cathode assemblies showing electrical and mechanical connectivity between the two assemblies in accordance with the electrode assembly of FIG. 5.

FIG. 10 shows a perspective elevation (isometric view) of the spacer plate and lateral spacer, used to support and provide rigidity to the electrode assembly of FIG. 5;

FIG. 11 is a separate perspective elevation (isometric view) of the circular spacer shown in FIG. 10;

FIG. 12 is a separate perspective elevation (isometric view) of the lateral spacer shown in FIG. 10;

FIG. 13 shows an exploded 2D view of the assembly between the current collectors and the related flanged fitting of the electrochemical reactor of the present invention; in this embodiment, an O-ring is illustrated as the means to prevent liquid leaks from the assembly between the flanged fitting and the hollow cylindrical element acting as the cell stack containment housing.

### DETAILED DESCRIPTION

The present invention concerns an electrochemical reactor for the in-line treatment of water/wastewater or, more in general, aqueous solutions containing halides and, in particular, for the electrolytic treatment of drinking water with the aim of maintaining or improving the quality of water in water supplies, swimming pools, ponds, irrigation waters, aquatic mammal tanks, spas, fountains, cooling towers and the like, and for the destruction of targeted contaminants (which can also be of microbiological nature) in water/wastewater streams such as from municipal water/wastewater treatment plants, ground water streams, industrial water/wastewaters and water from larger bodies such as streams and rivers, and for the preparation of lixiviant solutions suitable for solution mining applications.

In one aspect, the invention comprises an apparatus for generating a mixed oxidant stream containing oxidants such as: ozone, hydrogen peroxide and other peroxide species, hydroxyl radicals, as well as chlorine-based oxidants, the quantities and concentrations of which are determined by the quantity and type of compounds precursors that are fed into the electrochemical reactor, the water flow rate, the intensity of the current fed to the electrochemical reactor, and the electrode material.

In another aspect, the invention provides an electrochemical reactor fit for purpose and able to pass the Hydrostatic Pressure test, Endurance test, and Burst Pressure test prescribed by the regulations relevant to drinking water (e.g., WMTS-103), with reference to the effect that materials and products may have on the quality of water. In particular, the electrochemical reactor of the present invention showed to be able to withstand a permanent hydrostatic pressure of 3.5 MPa (or 35 bars) when tested at ambient temperature, or a permanent hydrostatic pressure of 2.0 MPa (or 20 bars) when tested at 50° C.

Under a further aspect, the present invention provides an electrochemical reactor which is capable of coping with the limited conductivity of drinking water, thanks to the extended electrode surface and limited distance between the electrode plates in the electrode assembly. Drinking water typically, and mostly, contains chloride ions and sodium ions; other chemical species may be sulphates, carbonates, calcium and magnesium ions; to a minor extent, also iron, manganese, phosphate and nitrate ions can be found, as well as dissolved gases including oxygen, carbon dioxide and nitrogen.

In describing preferred embodiments of the present invention illustrated in the figures, specific terminology is employed for the sake of clarity. The invention, however, is not intended to be limited to the specific terminology so selected, and it is to be understood that each specific element includes all technical equivalents that operate in a similar manner to accomplish a similar purpose.

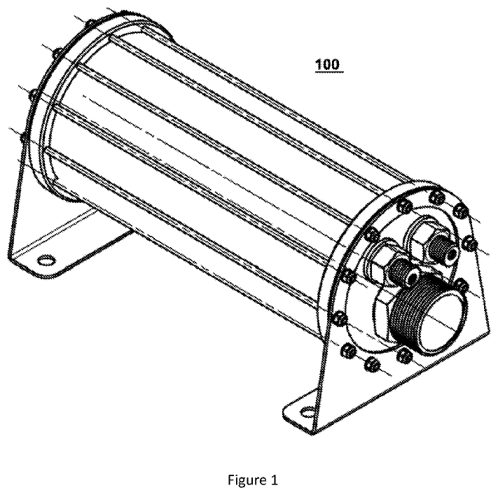

As shown in FIG. 1, the electrochemical reactor 100 of the present invention is an appliance that needs to be connected in-line to a source of water (not shown) by using inlet fitting 101a and outlet fitting 101b; however, it should be noted that it is also possible to reverse the flow direction of the fluid to be treated inside the reactor, i.e. using the fitting 101a as an outlet and the fitting 101b as an inlet. The electrochemical reactor 100 preferably is a hollow cylindrical element, having a cell stack containment housing 102 formed of electrically insulating material, such as unplasticized polyvinyl chloride (“uPVC”) tubing, preferably obtained by cutting to size a Schedule 80 PVC pipe (i.e., a pipe for the distribution of pressurised liquids, compliant with ASTM D 1785 standard).

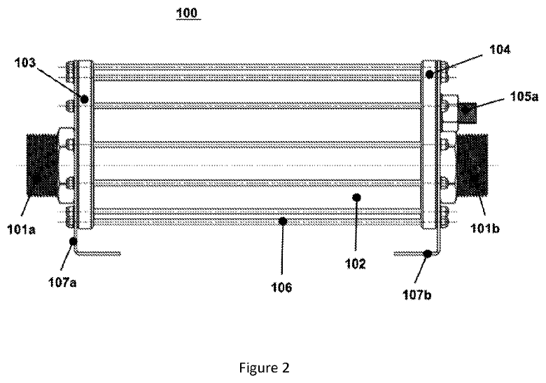

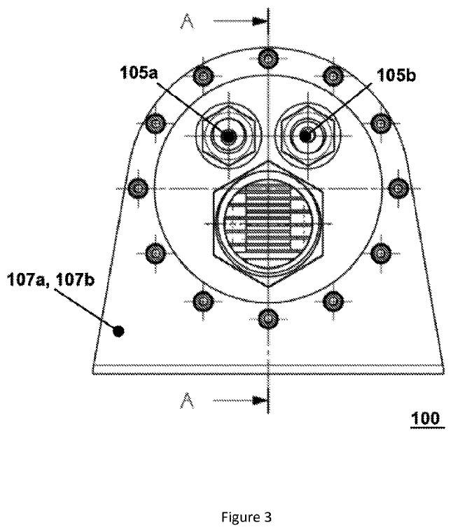

FIG. 1-3 shows the cell stack containment housing 102 oriented horizontally, although it should be noted that the present invention can be mounted in any orientation, from horizontal to vertical. In a preferred embodiment of the present invention, the cell stack containment housing 102 is provided with flanged fittings 103 and 104, or other suitable removable cap sufficient to support the electrode assembly 110, preferably also made of uPVC. In order to withstand the high hydraulic pressure prescribed by the Hydrostatic Pressure test, Endurance test, and Burst Pressure test of WMTS-103, the electrochemical reactor 100 of the present invention is equipped with metal clamping rods 106 fixed to the flanged fittings 103 and 104; to prevent liquid leaks, the flanged fittings 103 and 104 are also equipped with O-rings or gaskets. When O-rings are used, they are preferably inserted into a recess 138 created in the body of the flanged fitting, while in the case of the gaskets, they are housed between the flanged fitting and the hollow cylindrical element 102. In a preferred embodiment of the present invention, the electrochemical reactor 100 of the invention is also equipped with a pair of metal supports 107a,107b which, in addition to allowing the electrochemical reactor to be laid and fixed to the ground or on a wall, also allow a more uniform distribution of the tensions.

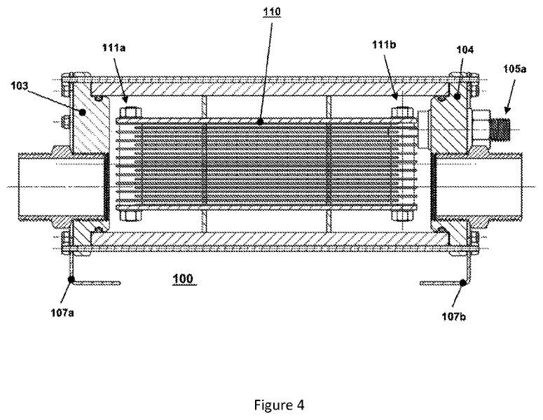

FIG. 4 shows a sectional view of the electrochemical reactor 100. A pair of metal current collectors 105a and 105b are mounted through the flange fitting 104, which allow to connect stacks of electrodes 111a,111b to a direct current power supply, through wires that are shown in FIG. 13. Due to their similar construction, the current connectors 105a and 105b are described without reference to polarity, although it should be understood that, during operation, one current connector will be used as the cathode and the other current connector will be used as the anode.

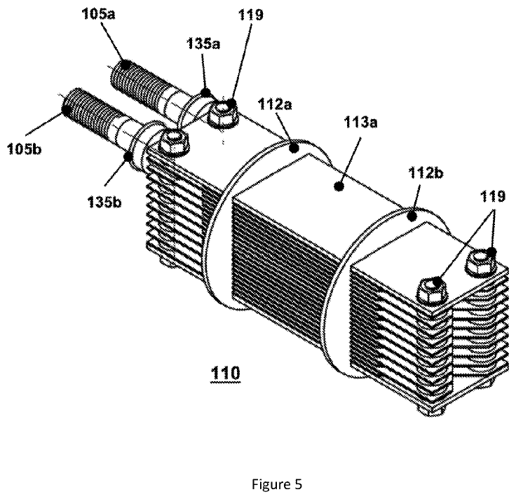

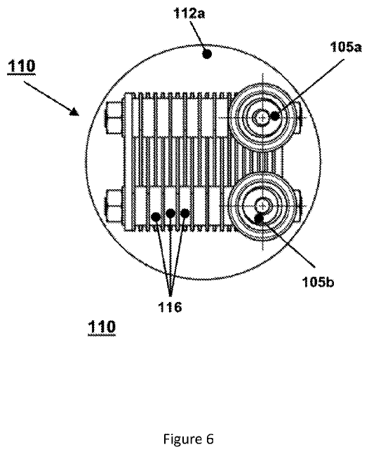

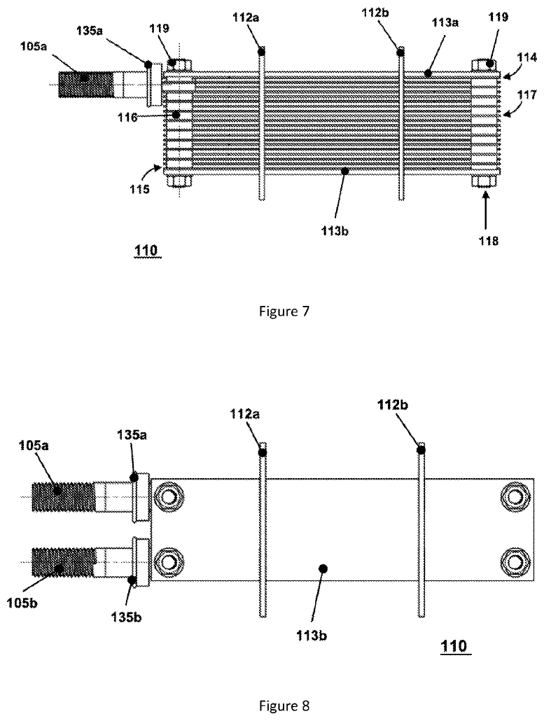

FIGS. 5-8 and 9 illustrate the details of a preferred layout of the electrode assembly 110, which comprises interlaced electrode stacks 111a and 111b. Electrical power is supplied to the electrode assembly 110 via current collector 105a,105b. Electrodes in interlaced electrode stack 111a,111b are additionally mechanically connected by metal threaded rod 118 by means of metal nuts 119, as described in more detail below in association with FIG. 9.

FIG. 9 illustrates the construction of the electrode stacks 111a and 111b, of electrode assembly 110. It should be noted that, where components are redundant, only one component is described for clarity and simplicity. As shown, the electrode stack 111a,111b consists of a plurality of metal plate electrodes 117. All metal parts in contact with the fluid to be treated, and especially those comprised in electrode assembly 110, are made of an electrically conducting material, metal, metal alloy or glassy carbon; it is preferable to use either titanium (pure or containing any impurity) or a metal alloy in which titanium is the major component; other valve metals can be considered (such as tantalum, zirconium or niobium), as well as nickel, copper or stainless steel. Regarding electrodes, the electrically conductive substrate can then be coated with a suitable catalyst, which typically includes those noble metals of the platinum family (Ir, Ru, Os, Rh, Pd, Pt), their oxides, either pure or blended with other oxides, and particularly with valve metal oxides as well as oxides of titanium, tantalum, zirconium, niobium and tin. Each electrode 117 has a thickness of between 0.1 mm and 4 mm, and preferably between 1 mm and 2 mm; net electrodes or perforated plate electrodes can also be considered.

In a preferred embodiment of the present invention, the metal plate electrodes are preferably formed of titanium, with those electrodes connected to the positive power supply being coated with a mixed oxide coating and those electrodes connected to the negative power supply being uncoated or coated with a mixed oxide coating. It will be recognised by those of ordinary skill in the art that the normal operating polarity just described may be electrically reversed in order to provide cleaning of the electrode assembly 110. In a preferred embodiment of the present invention, the polarity is periodically reversed. This operation can be performed every hour, or every 10 minutes; more generally, the polarity can be reversed at time intervals between about 1 and 1440 minutes, said time interval being chosen according to the characteristics of the fluid to be treated, and the current fed to the electrochemical reactor.

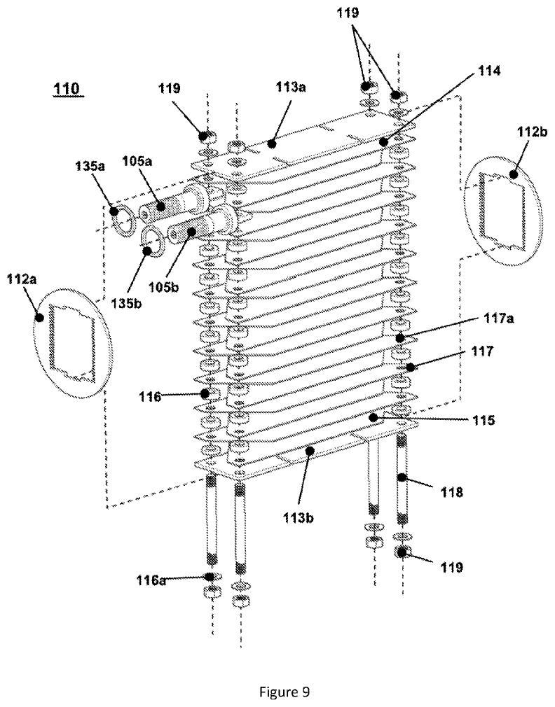

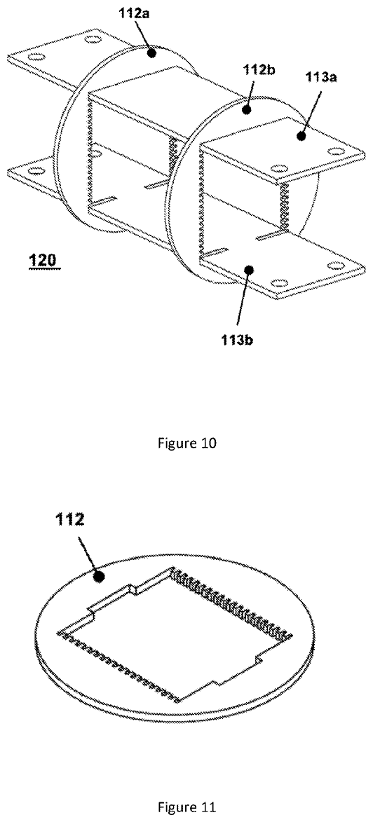

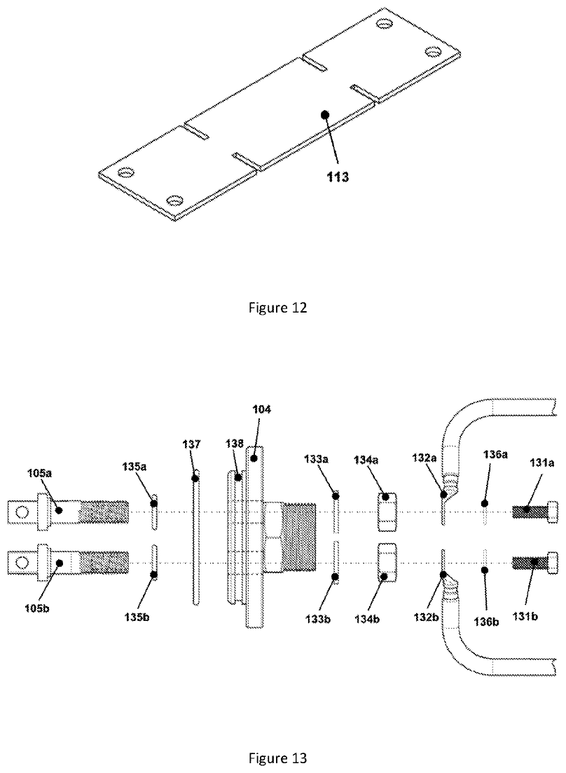

Circular spacers 112a and 112b are made of insulating plastic material (e.g. PVC) and have a central opening provided with teeth/slots for receiving the electrode plates and keeping them uniformly separated and with seats that allow the coupling with the lateral spacers 113a and 113b, also made of insulating plastic material (e.g. PVC) and sized in such a way as to allow the assembly of the electrode holder structure 120 shown in FIG. 10. The spacing between the electrode plates is generally comprised between 0.5 mm and 15 mm, yet preferably comprised between 1 mm and 3 mm. Once assembled, the electrode holder structure 120 is locked in position by inserting the lateral electrode plates 114 and 115, which are respectively inserted through the seats in a position adjacent to the lateral spacer 113a,113b.

To provide electrical connectivity to the electrodes, a plurality of metal washers 116 are disposed between the electrodes 117 in correspondence with connection holes 117a, as shown in FIG. 9, so as to electrically connect the electrodes 117, bridging and separating them. The thickness of the metal washers depends on the spacing between the teeth in the circular spacer 112a,112b and on the thickness of the electrode plates; for example, using 1 mm thick electrode plates, and in order to obtain a 2 mm gap between the electrodes, the thickness of the metal washer 116 should be 5 mm; however, thinner metal washers are used in correspondence with the lateral spacer 113a,113b. To provide further electrical connectivity between electrode plates in electrode assembly 110, a metal current header connecting rod 118 threaded at the ends is passed into hole 117a of the electrodes and tightened with metal nuts 119. An additional metal washer 116a can be located between the nut 119 and the lateral spacer 113a,113b to allow for a more uniform distribution of the tensions. In a preferred embodiment, the mechanical and electrical configuration of the cathode assembly and the anode assembly will be essentially identical, each being a mirror image of one another.

FIG. 13 illustrates the assembly between the current collectors 105a,105b and the related flanged fitting 104 of the electrochemical reactor of the present invention. Particularly advantageous for the present invention, the metal current collector 105a,105b engages with a metal screw 131a,131b, an optional metal washer 136a,136b, and a flat tab cable metal lug 132a,132b using a thread present inside the current collector 105a,105b. The current collector 105a,105b is secured to the flange fitting 104 by means of a metal flat washer 133a,133b, and a metal nut 134a,134b. A metal spring washer can be added between the metal flat washer and the metal nut to improve tightening. To prevent fluid leakage, especially under pressure, and to accommodate dimensional changes due to thermal cycling and resistive heating, the O-ring 135a,135b is positioned between the current collector 105a,105b and the flange fitting 104. By tightening the metal nut 134a,134b, the current collector 105a,105b presses the O-ring 135a,135b against the flanged fitting 104, which provides the required seal. Those skilled in the art will recognise that tightening the nut 134a,134b can cause the current collector 105a,105b to twist. Since each current collector 105a,105b is firmly connected to the respective electrode stack 111a,111b, any rotation of the current collector 105a,105b would cause the corresponding electrode stack 111a,111b to rotate at the same time, with consequent risk of bringing one electrode stack in contact with the other, and thus causing an internal short circuit. The authors of the present invention have discovered that the electrode holder structure 120 is indispensable for preventing an internal short circuit due to the rotation of the electrodes and/or of the current collector.

In a preferred configuration, the screw 131a,131b and the flat tab cable lug 132a,132b are made of brass; this also allows improving the electric conductivity of the current collector. In this embodiment, an O-ring 137 is illustrated as the means to prevent liquid leaks from the assembly between the flanged fitting 104 and the cell stack containment housing 102 (not shown). During the assembly of the electrochemical reactor 100, the O-ring is inserted into the recess 138 created in the body of the flanged fitting 103,104.

With reference to FIGS. 9 and 10, circular spacers 112a and 112b have not only the function of keeping separated the electrode plates 117 and of supporting the electrode holder structure 120 inside the cell stack containment housing 102, but also of forcing the water/wastewater to be treated within the electrochemical reactor of the present invention to pass inside the electrode stacks 111a,111b. In a preferred embodiment of the present invention, the diameter of the circular spacer 112a,112b is equal to or just less than the internal diameter of the cell stack containment housing 102.

In a preferred embodiment, the electrode assembly 110 comprises closely spaced and interlaced plate electrodes with all surfaces of the electrodes capable of being wetted by the fluid to be treated except those surfaces in contact with the insulating plastic material of the lateral spacers 113a,113b, and represents both a passage for said fluid and an electrolysis chamber having a cross section at least as great as the cross section of the fluid inlet fitting (101a) and the fluid outlet fitting (101b) from the electrochemical reactor.

The features described above make the present invention more economical, efficient, and safer than other prior art devices, and therefore represent a clear advance over other prior art devices.

All references cited herein are incorporated by reference in their entireties.

1. An electrochemical reactor for the inline treatment of water/wastewater, comprising an electrode assembly within a cell stack containment housing, the electrode assembly including a plurality of electrode plates, at least two circular spacers, each having a central opening having a plurality of apertures/slots for receiving and spacing apart the plurality of electrode plates, and at least two lateral spacers inserted into the central openings of the at least two circular spacers, each having slots to engage with the at least two circular spacers;
wherein the electrode assembly comprises closely spaced and interlaced electrodes enclosed within an electrode holder structure, the at least two circular spacers having diameter equal to or just less than an internal diameter of the cell stack containment housing to force the water/wastewater to be treated to pass inside the electrode stacks.

2. The reactor according to claim 1, wherein said reactor is able to withstand a permanent hydrostatic pressure of 3.5 MPa (or 35 bars) when tested at ambient temperature, or a permanent hydrostatic pressure of 2.0 MPa (or 20 bars) when tested at 50° C.

3. The reactor according to claim 1, wherein the electrode assembly represents both a passage for the water/wastewater to be treated and an electrolysis chamber having a cross section at least as great as the cross section of the fluid inlet fitting and the fluid outlet fitting from the electrochemical reactor.

4. The reactor according to claim 1, wherein said reactor is used for generating a mixed oxidant stream containing oxidants such as: ozone, hydrogen peroxide and other peroxide species, hydroxyl radicals, as well as chlorine-based oxidants, the quantities and concentrations of which are determined by the quantity and type of compounds precursors that are fed into the reactor, the water flow rate, the intensity of the current fed to the reactor, and the electrode material.

5. The reactor according to claim 1, wherein the mechanical and electrical configuration of the cathode assembly and the anode assembly are essentially identical, each being a mirror image of one another.

6. The reactor according to claim 1, wherein said reactor is used for the electrolytic treatment of drinking water with the aim of maintaining or improving the quality of water in water supplies, swimming pools, ponds, irrigation waters, aquatic mammal tanks, spas, fountains, cooling towers and the like, and for the destruction of targeted contaminants (which can also be of microbiological nature) in water/wastewater streams such as from municipal water/wastewater treatment plants, ground water streams, industrial water/wastewaters and water from larger bodies such as streams and rivers, and for the preparation of lixiviant solutions suitable for solution mining applications.

7. The reactor according to claim 1, wherein said reactor is installed in-line with the water/wastewater network to be treated.

8. The reactor according to claim 1, wherein all metal parts in contact with the fluid to be treated, and especially those comprised in electrode assembly, are made of an electrically conducting material, metal, metal alloy or glassy carbon.

9. The reactor according to claim 8, wherein said metal parts are made of either titanium (pure or containing any impurity) or of metal alloys in which titanium, tantalum, zirconium or niobium are the major components.

10. The reactor according to claim 1, wherein the electrodes are coated with a suitable catalyst, which typically includes those noble metals of the platinum family (Ir, Ru, Os, Rh, Pd, Pt), their oxides, either pure or blended with other oxides, and particularly with valve metal oxides as well as oxides of titanium, tantalum, zirconium, niobium and tin.

11. The reactor according to claim 10, wherein the electrodes have a thickness of between 0.1 mm and 4 mm, and preferably between 1 mm and 2 mm.

12. The reactor according to claim 1, wherein the normal operating polarity is electrically reversed in order to provide cleaning of the electrode assembly.

13. The reactor according to claim 12, wherein the polarity is reversed at time intervals between 1 and 1440 minutes, said time interval being chosen according to the characteristics of the fluid to be treated, and the current fed to the reactor.

14. The reactor according to claim 1, wherein said reactor is equipped with metal clamping rods fixed to flanged fittings.

15. The reactor according to claim 1, wherein said reactor is equipped with a pair of metal supports that, in addition to allowing the reactor to be laid and fixed to the ground or on a wall, also allow a more uniform distribution of tensions.

16. The reactor according to claim 1, wherein said reactor is equipped with a pair of metal current collectors mounted through the flange fitting, which allow to connect stacks of electrodes to a direct current power supply.

17. The reactor according to claim 1, wherein the spacing between the electrode plates is comprised between 0.5 mm and 15 mm.

18. The reactor according to claim 1, wherein a plurality of metal washers are disposed between the electrodes in correspondence with connection holes, so as to electrically connect said electrodes, bridging and separating them.

19. The reactor according to claim 18, wherein the thickness of the metal washers depends on the spacing between the teeth in the circular spacer and on the thickness of the electrode plates.

20. The reactor according to claim 1, wherein O-rings are positioned between the current collectors and the flange fitting in order to prevent fluid leakage, especially under pressure.

21. The reactor according to claim 1, wherein an electrode holder structure is used to prevent an internal short circuit due to the rotation of the electrodes and/or of the current collectors.

22. The reactor according to claim 1, wherein an O-ring is inserted into a recess created in the body of the flanged fitting to prevent liquid leaks from the assembly between the flanged fitting and the cell stack containment housing.
